(19) United States
(12) Patent Application Publication
(10) Pub. No.: US 2007/0141532 A1
(43) Pub. Date: Jun. 21, 2007

(54) Force distributing dental implant assembly

(76) Inventors: Christopher W. Ford, Holly, MI (US); Boney A. Mathew, Clarkston, MI (US)

Correspondence Address: HARNESS, DICKEY & PIERCE, P.L.C., P.O. BOX 828, BLOOMFIELD HILLS, MI, 48303, US

(21) Appl. No.: 11/312,996

(22) Filed: Dec. 20, 2005

(51) Int. Cl. A61C 8/00

(52) U.S. Cl. 433/173

(57) ABSTRACT

A dental implant assembly that can be attached to a bone of a person. The dental implant assembly includes an anchor adapted for attachment to the bone and an insert attached to the anchor. The insert is adapted for attachment to a tooth-replacing device having an occlusal bearing surface. The insert is adapted to transfer force from the bearing surface to the anchor such that the tooth-replacing device is able to resiliently move relative to the anchor. Also, at least one of the anchor and the insert is at least partially made out of a polymeric material. In one embodiment, the insert includes a resilient adhesive layer.

### FIELD OF THE INVENTION

The present invention relates to a dental implant assembly and more particularly relates to a force distributing dental implant assembly.

### BACKGROUND OF THE INVENTION

Dental implants of numerous and varying designs have existed for many years. Many prior art dental implants include artificial teeth that are attached inside a patient's mouth to replace lost teeth and to restore natural dental function.

Although prior art dental implants have worked for their intended purpose, some disadvantages remain. For instance, an implant can become overloaded during the patient's use and can become loose due to bone loss. In more extreme cases, the implant can break due to excessive loading.

In an effort to produce long lasting implants, reduce breakage and reduce prosthetic failure, the prior art contains examples of multiple implants, varying orientation of implants, varying diameter and lengths of implants, implant protected occlusion, varying surface areas, occlusal table width, varying loading schedules, varying implant locations, splinting, patient selection, soft tissue considerations, and the like. See, for example: U.S. Pat. Nos. 5,453,007 to Wagher; 5,040,982 to Stefan-Dogar; 5,468,150 to Brammann; 4,657,510 to Gittleman; 5,503,558 to Clokie; 4,259,072 to Hirabayashi et al.; 4,568,285 to Chiaramonte et al.; 4,938,693 to Bulakiev; 4,609,354 to Koch; 5,425,639 to Anders; 5,362,235 to Daftary; “Clinical And Statistical Analysis Of A Comprehensive Implant Reconstructive Practice: by Richard A. Borgner, DDS Dental Economics, October 1995, p. 96; “Survival Rates of Hemisected Teeth: An Attempt to Compare them with Survival Rates of Alloplastic Implants” by Buhler, Hans, Endodontics/Peridontics Review, Fall 1996; “Early Bone Loss Etiology And its Effect on Treatment Planning” by Carl E. Misch, DDS, MDS, Dentistry Today, June 1996, pp. 44-51; “From Subperiosteal to Osseointegration: An Unusual Demand Met by an Unusual Approach” by Gary H. Ganz, DDS, PC, Dentistry Today, October 1995, pp. 49-51; “Controlling Forces on Dental Implants” by Dr. Paul Homoly, Dentistry Today, October 1995, pp. 46-47; “Osseointegrated Implants With an Intramobile Element in the Treatment of Edentulous Jaws” by Alan F. Shernoff, DDS et al., Compend Contin Educ Dent, Vol. XII, No. 6, pp. 394-402; Implant-Protected Occlusion” by Carl E. Misch, DDS, MDS and Martha W. Bidez, PhD, PP&A, Vol. 7, No. 5, pp. 25-29; “Interrelations of Soft and Hard Tissues for Osseointegrated Implants” by Oded Bahat, BDS, MSD, Compendium, December 1996, Vol. 17, No. 12 pp. 1161-1167; “Diagnosis and Evaluation of Complications and Failures Associated With Osseointegrated Implants” by Harold S. Baumgarten, DMD and Gerald J. Chiche, DDS, Compendium, August 1995, Vol. 16, No. 8, pp. 814-823; “Techniques for Ideal Implant Placement in the Mandibular First Molar Position” by Louis F. Clarizio, DDS, Compendium, August 1995, Vol. 16, No. 8, pp. 806-813; and “Implant-Protected Occlusion: A Biomechanical Rationale” by Carl F. Misch, DDS, MDS and Martha Warren Bidez, PhD, Compendium, November 1994, Vol. 15, No. 11, pp. 1330-1343.

However, a significant reason for breakage and loosening of conventional dental implants is that most prior art devices do not allow the implant to resiliently move relative to the jaw bone. The prior art has therefore resulted in implants that are often directly attached to the bone and that cannot flex with the bone. Loads are, therefore, concentrated at the jaw bone. This concentration of stress on the bone results in the physiological phenomenon known as resorption. The density and mass of the jaw bone decreases, eroding support for the implant. The final result is loss of the implant due to lack of support.

Furthermore, conventional dental implants are typically made of ceramics and/or metal material, such as titanium. These materials can be prohibitively expensive, and manufacturing the dental implants using these materials can be difficult as well. Furthermore, installing these conventional dental implants can be difficult and time consuming.

Accordingly, there remains a need for a dental implant that can resiliently move relative to the jaw bone and that is made out of less expensive materials. There also remains a need for a dental implant that can be manufactured more easily. Furthermore, there remains a need for a dental implant that can be installed more easily than conventional dental implants.

### SUMMARY OF THE INVENTION

The disadvantages of the prior art are overcome in a dental implant assembly that can be attached to a bone of a person. The dental implant assembly includes an anchor adapted for attachment to the bone and an insert attached to the anchor. The insert is adapted for attachment of a tooth-replacing device having an occlusal bearing surface. The insert is adapted to transfer force from the bearing surface to the anchor such that the tooth-replacing device is able to resiliently move relative to the anchor. Also, at least one of the anchor and the insert is at least partially made out of a polymeric material.

In another aspect, a dental implant assembly can be attached to an attachment surface for chewing by a person. The dental implant assembly includes a core that is adapted for attachment to a tooth-replacing device having an occlusal bearing surface. The dental implant assembly also includes a resilient adhesive layer adapted for adhesively coupling the core to the attachment surface. The resilient adhesive layer is also adapted for transferring force from the bearing surface to the attachment surface such that the tooth-replacing device is able to resiliently move relative to the attachment surface.

The dental implant assembly allows for resilient movement of the tooth-replacing device relative to the bone of the patient. As such, the dental implant assembly remains useful and operational for a longer amount of time. The dental implant assembly can also be easier to manufacture and install. Also, the dental implant assembly can be less expensive than those of the related art.

Further areas of applicability of the present invention will become apparent from the following detailed description. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present teachings will become more fully understood from the detailed description and the accompanying drawings, wherein:

FIG. 1 is an exploded side view of one embodiment of a dental implant assembly of the present disclosure;

FIG. 2 a sectional side view of the dental implant assembly of FIG. 1 shown in an installed state; and

FIG. 3 is a sectional side view of another embodiment of a dental implant assembly of the present disclosure.

### DETAILED DESCRIPTION OF THE PREFERRED EMBODIMENTS

The following description is merely exemplary in nature and is in no way intended to limit the invention, its application, or uses.

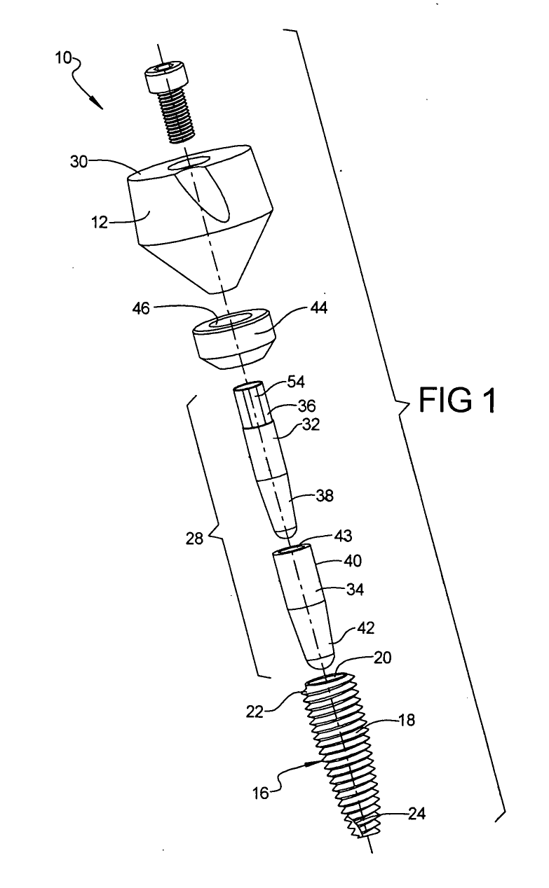

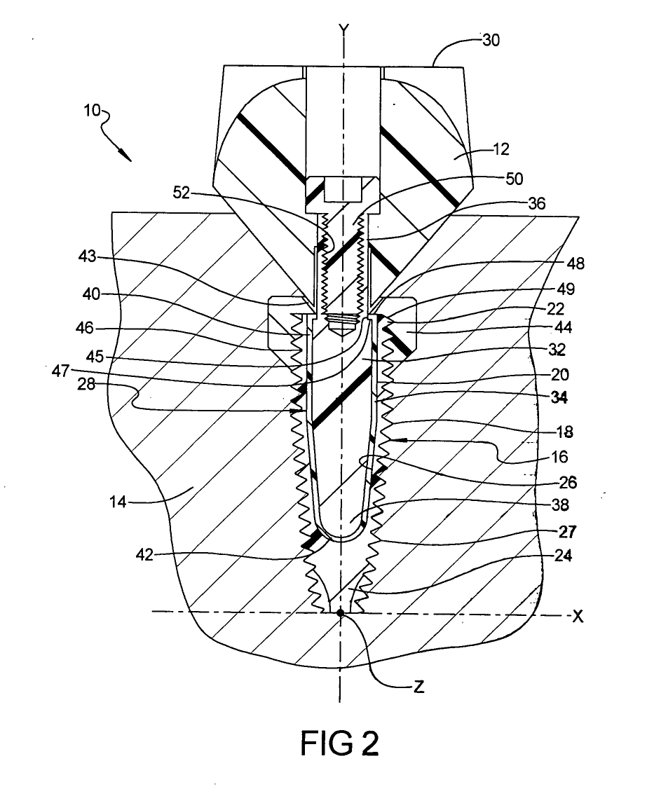

Referring now to the drawings, and in particular, FIGS. 1 and 2, one embodiment of a dental implant assembly 10 is illustrated. The dental implant assembly 10 can be of a type disclosed in applicant's U.S. Pat. No. 5,954,505, entitled “Force Distributing Dental Implant,” which issued on Sep. 21, 1999, of which the specification and drawings are hereby incorporated in their entirety by reference. Generally speaking, a tooth-replacing device 12, such as an artificial tooth (schematically illustrated in FIGS. 1 and 2), can be indirectly attached to a person's jaw bone 14 (FIG. 2) via the dental implant assembly 10. As such, the tooth-replacing device 12 allows for chewing by the person and preferably restores normal dental function to the person.

In the embodiment shown in FIGS. 1 and 2, the dental implant assembly 10 includes an anchor 16. The anchor 16 is generally cylindrical and defines an outer attachment surface 18. The anchor 16 also includes a pocket 20 (FIG. 2) that extends partially through the anchor 16. More specifically, the pocket 20 extends from an open top end 22 toward a bottom end 24 along an axis Y of the dental implant assembly 10. The pocket 20 is ovoid in a plane that is perpendicular to the axis Y. The pocket 20 defines an inner attachment surface 26 (FIG. 2). In the embodiment shown, the anchor 16 is tapered such that the top end 22 is wider than the bottom end 24.

The anchor 16 is adapted for attachment to the bone 14 of the patient as shown in FIG. 2. Specifically, a hole 27 (FIG. 2) is surgically drilled in the bone 14, and the anchor 16 is placed therein. In the embodiment shown, the outer attachment surface 18 is threaded to facilitate attachment to the bone 14. However, those having ordinary skill in the art will appreciate that the outer attachment surface 18 of the anchor 16 could be smooth, vented, or otherwise and could be attached to the bone 14 by any suitable means without departing from the scope of the invention. The anchor 16 could also be coated with hydroxyapatite (HA) 12 or other suitable bone growth stimulants.

The anchor 16 can be made out of any suitable material. In one embodiment, the anchor 16 is made out of a metal, such as Titanium. In another embodiment, the anchor 16 is at least partially made out of a polymeric material. For instance, in one embodiment, the anchor 16 is a composite having both a polymeric material and reinforcing metallic material embedded within the polymeric material. In another embodiment, the anchor 16 is entirely made out of a polymeric material. The polymer used to make the anchor 16 is polyetheretherketone (PEEK) in one embodiment. When the anchor 16 is made out of a polymeric material, the dental implant assembly 10 can be less expensive and easier to install than those of the related art as will be discussed in greater detail below.

The dental implant assembly 10 also includes an insert, generally indicated at 28 in FIG. 1. The insert 28 can be attached to the anchor 16 and is also adapted for attachment to the tooth-replacing device 12 as shown in FIG. 2. The insert 28 has elastic properties to replicate the function of natural ligament or fibrous tissues holding a natural tooth and allowing movement of the tooth-replacing device 12 relative to the bone 14. More specifically, the tooth-replacing device 12 includes at least one occlusal bearing surface 30. Loads on the bearing surface 30 due to chewing or the like transfer through the insert 28, through the anchor 16, and to the bone 14. The insert 28 has elastic properties to allow resilient movement of the tooth-replacing device 12 relative to the anchor 16 and the bone 14 in response to loading. In one embodiment, the insert 28 allows resilient movement of the tooth-replacing device 12 with respect to three axes. More specifically, the bone 14 defines an inciso-cervical axis, a mesial-distal, and a buccal-lingual axis, each represented in FIG. 2 by the axes X, Y, and Z. The insert 28 allows resilient movement of the tooth-replacing device 12 with respect to at least one of—and preferably all of—these axes. As such, the operating life of the dental implant assembly 10 and the tooth-replacing device 12 is improved.

In the embodiment shown, the insert 28 includes a core 32 and a resilient member 34. The core 32 and the resilient member 34 of the insert 28 are each disposed within and substantially fill the pocket 20 of the anchor 16. For instance, in the embodiment shown, the core 32 is generally cylindrical so as to define a top end 36 and a bottom end 38, and the bottom end 38 is slightly tapered. The resilient member 34 is also generally cylindrical so as to define a top end 40 and a bottom end 42, which is tapered and rounded. The resilient member 34 is also hollow and includes an aperture 43 at the top end 40. The core 32 is sized so as to be substantially encapsulated by the resilient member 34 and such that the top end 36 of the core 32 extends out from the aperture 43 of the resilient member 34. In the embodiment shown in FIG. 2, the resilient member 34 includes a flange 45 that extends over a complimentary collar 47 of the core 32. The resilient member 34 is sized so as to fit within and substantially fill the pocket 20 of the anchor 16. As such, the resilient member 34 is interposed between the core 32 and the anchor 16 as shown in FIG. 2.

In the embodiment shown in FIGS. 1 and 2, the insert 28 is attached to the anchor 16 with a retaining member 44. The retaining member 44 is shaped like a ring and includes an inner attachment surface 46 (FIG. 2). In one embodiment, the inner attachment surface 46 is threaded, thereby allowing the retaining member 44 to be threadably engaged on the top end 22 of the outer attachment surface 18 of the anchor 16. The retaining member 44 also includes a flange 48 (FIG. 2) that extends inward from a top end 49 of the inner attachment surface 46. As shown in FIG. 2, the flange 48 extends over the pocket 20 of the anchor 16 when the retaining member 44 is threaded on the anchor 16. As such, the flange 48 interferes with the insert 28 to thereby couple the insert 28 to the anchor 16.

In another embodiment, the resilient member 34 is attached directly to the inner attachment surface 26 of the anchor 16 to thereby attach the insert 28 to the anchor 16. For instance, in one embodiment, the resilient member 34 is an adhesive layer that adhesively attaches the core 32 to the anchor 16. In such an embodiment, the retaining member 44 may not be necessary.

The core 32 is relatively rigid, and the resilient member 34 is generally resilient so as to allow resilient movement of the tooth-replacing device 12. For instance, in one embodiment, the core 32 is made out of a metal material, such as titanium. In another embodiment, the core 32 is at least partially made out of a polymeric material. For instance, in one embodiment, the core 32 is a composite having both a polymeric material and reinforcing metallic material embedded within the polymeric material. In another embodiment, the core 32 is entirely made out of a polymeric material. The polymer used to make the core 32 is polyetheretherketone (PEEK) in one embodiment. The resilient member 34, on the other hand, is at least partially made out of a resilient polymeric material, such as nylon, POM, LLDPE, polyurethane, combinations of those materials, and the like. In one embodiment, the resilient member 34 is entirely made out of a resilient polymeric material. It should be appreciated that in cases where the core 32 and/or the resilient member 34 are made out of a polymeric material, the dental implant assembly 10 can be easier and less expensive to manufacture, the dental implant assembly 10 can be lighter in weight, and the dental implant assembly 10 can be easier to install.

As shown in FIG. 2, the top end 36 of the core 32 includes a pocket 50 extending axially through the top end 36 of the core 32. The pocket 50 defines an inner attachment surface 52. In the embodiment shown, the inner attachment surface 52 is threaded. A fastener extends through the tooth-replacing device 12 and is threaded into the pocket 50 to attach the tooth-replacing device 12 to the core 32. Also, the top end 36 of the core 32 includes a plurality of planar outer surfaces 54 (FIG. 1). For instance, the top end 36 is polygonal or square in a cross section taken along the X-Z plane of FIG. 2. The planar outer surfaces 54 facilitate installation and/or removal of the tooth-replacing device 12.

In one specific embodiment, the anchor 16 measures approximately 3.5 mm in diameter, 10 mm in length, and has approximately a 7.4 degree taper relative to the Y axis. The anchor 16 also has a M3.5×0.6 thread on the outer attachment surface 18. The core 32 is approximately 6.82 mm in length, and 2.1 mm in diameter. The planar outer surfaces 54 of the core 32 are approximately 2.0 mm in length. The pocket 50 of the core 32 measures approximately 1.8 mm in diameter. When the core 32 is disposed within the pocket 20 of the anchor 16, the space between the core 32 and the anchor 16 (i.e., the wall thickness of the resilient member 34) is approximately 0.18 mm. The resilient member 34 is approximately 7.0 mm in length. The retaining member 44 is approximately 4.5 mm in diameter and 2.2 mm in length. The flange 48 of the retaining member 44 is approximately 0.5 mm in length. However, those having ordinary skill in the art will appreciate that the anchor 16, core 32, resilient member 34, and retaining member 44 could be of any suitable size and dimension without departing from the scope of the invention.

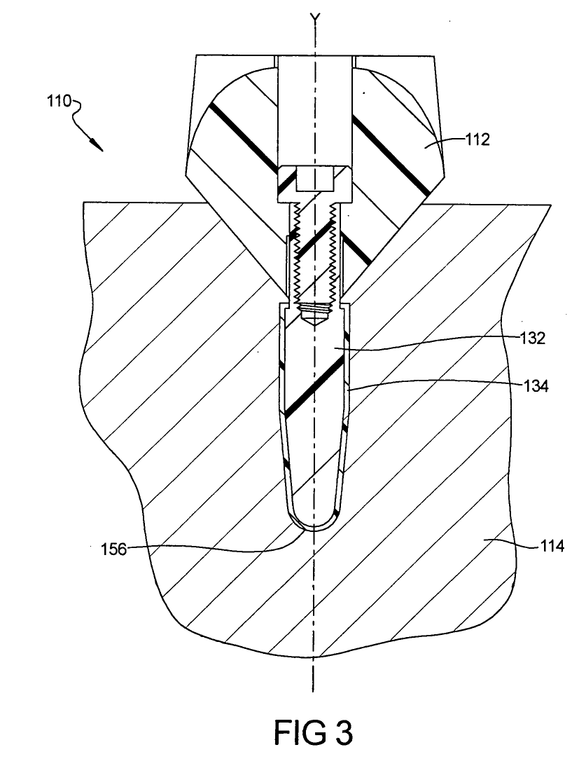

Turning now to FIG. 3, another embodiment of the dental implant assembly 110 is shown, where like numerals increased by 100 are used to designate like structure with respect to the embodiment illustrated in FIGS. 1 and 2. In the embodiment shown in FIG. 3, the dental implant assembly 110 includes a core 132 that can be coupled to a tooth-replacing device 112. The dental implant assembly 110 also includes a resilient member 134. In this embodiment, however, the resilient member 134 is an adhesive layer that adhesively attaches the core 132 to an attachment surface 156 formed in the bone 114 of the patient. The adhesive used to form the resilient member 134 can be of any suitable type, such as polyurethane, cyanoacrylate, epoxy with or without an additive, and the like. Preferably, the adhesive used to form the resilient member 134 is resiliently flexible to allow resilient movement of the tooth-replacing device 112.

In summary, the dental implant assembly 10, 110 allows for resilient movement of the tooth-replacing device 12, 112 relative to the bone 14, 114 of the patient. As such, the dental implant assembly 10, 110 remains useful and operational for a longer amount of time. The dental implant assembly can also be easier to manufacture and install. Also, the dental implant assembly 10, 110 can be less expensive than those of the related art.

The description of the disclosure is merely exemplary in nature and, thus, variations that do not depart from the gist of the invention are intended to be within the scope of the disclosure. Such variations are not to be regarded as a departure from the spirit and scope of the disclosure.

1. A dental implant assembly that can be attached to a bone of a person comprising:
an anchor made out of a polymeric material for attachment to the bone; and
an insert including a core made out of a polymeric material, said insert attached to said anchor, said core adapted for attachment to a tooth-replacing device having an occlusal bearing surface, and wherein said insert is adapted to transfer force from the bearing surface to said anchor such that the tooth-replacing device is able to resiliently move relative to said anchor, said insert enabling resilient movement of the tooth-replacing device with respect to at least one of the inciso-cervical, mesial-distal and buccal-lingual axes for increasing the operating life of said dental implant assembly.

2. The dental implant assembly of claim 1, wherein said anchor and said core is entirely made out of a polymeric material.

3. The dental implant assembly of claim 1, wherein said insert further includes a resilient member interposed between said core and said anchor, said resilient member adapted to transfer force from said core to said anchor.

4. The dental implant assembly of claim 3, wherein said resilient member is an adhesive layer attaching said core to said anchor.

5. The dental implant assembly of claim 3, wherein said resilient member is made of a polymeric material chosen from a group consisting of nylon, POM, LLDPE, polyurethane, and combinations thereof.

6. The dental implant assembly of claim 1, wherein said core and anchor may include a reinforcement material.

7. The dental implant assembly of claim 1, further comprising a retaining member that is attached to said anchor and that includes a flange that interferes with said insert to thereby couple said insert to said anchor.

8. The dental implant assembly of claim 7, wherein said anchor includes a threaded outer surface, and said retaining member is threadably engaged on said outer surface of said anchor.

9. The dental implant assembly of claim 7, wherein said anchor includes a pocket, said insert is disposed within said pocket, and wherein said flange extends over said pocket to thereby interfere with said insert and couple said insert to said anchor.

10. (canceled)

11. A dental implant assembly that can be attached to an attachment surface formed in a jaw bone of a person receiving the dental implant assembly, said dental implant assembly comprising:
a core adapted for attachment to a tooth-replacing device having an occlusal bearing surface; and
a resilient adhesive layer adapted for adhesively coupling said core to the attachment surface of the jaw bone and adapted for transferring force from the bearing surface to the attachment surface such that the tooth-replacing device is able to resiliently move relative to the attachment surface of the jaw bone.

12. (canceled)

13. The dental implant assembly of claim 11 further comprising an anchor adapted for attachment to a bone, wherein said anchor includes the attachment surface.

14. The dental implant assembly of claim 13, wherein said anchor is at least partially made of a polymeric material.

15. The dental implant assembly of claim 14, wherein said anchor is at least partially made out of polyetheretherketone (PEEK).

16. The dental implant assembly of claim 11, wherein said core is at least partially made of a polymeric material.

17. The dental implant assembly of claim 16, wherein said core is at least partially made out of polyetheretherketone (PEEK).

18. The dental implant assembly of claim 11, wherein a bone of the person defines an inciso-cervical axis, a mesial-distal axis, and a buccal-lingual axis, and wherein said core can resiliently move with respect to the bone along at least one of the inciso-cervical, mesial-distal, and buccal-lingual axes.

19. A dental implant assembly that can be attached to a bone of a person comprising:
an anchor made out of a polymeric material for attachment to the bone; and
an insert including a core made out of a polymeric material, said insert attached to said anchor, said core adapted for attachment to a tooth-replacing device having an occlusal bearing surface, and wherein said insert includes a core and a resilient member interposed between said core and said anchor, said resilient member adapted to transfer force from said core to said anchor such that the tooth-replacing device is able to resiliently move relative to said anchor, said insert enabling resilient movement of the tooth-replacing device with respect to at least one of the inciso-cervical, mesial-distal and buccal-lingual axes for increasing the operating life of said dental implant assembly.

20. The dental implant assembly of claim 19, wherein said resilient member is an adhesive layer attaching said core to said anchor.

21. The dental implant assembly of claim 19, wherein said anchor, said core, and said resilient member are each entirely made out of a polymeric material.
